(19) United States
(12) Patent Application Publication
(10) Pub. No.: US 2026/0021661 A1
(43) Pub. Date: Jan. 22, 2026

(54) PRINTING APPARATUS, CONTROL METHOD, AND STORAGE MEDIUM

(71) Applicant: CANON KABUSHIKI KAISHA, Tokyo (JP)

(72) Inventors: SATOSHI AZUMA, Tokyo (JP); YOSHIAKI MURAYAMA, Tokyo (JP); JUN YASUTANI, Kanagawa (JP); KENTARO MURO, Tokyo (JP); TAKUTO MORIGUCHI, Kanagawa (JP); OSAMU YOSHITAKE, Chiba (JP)

(21) Appl. No.: 19/270,578

(22) Filed: Jul. 16, 2025

(30) Foreign Application Priority Data
Jul. 18, 2024 (JP) 2024-114668

(51) Int. Cl. B41J 2/165; B41J 2/21

(52) U.S. Cl. CPC B41J 2/16526; B41J 2/2103; B41J 2002/16573

(57) ABSTRACT

In a case of conducting first printing on a first printing medium whose width in a first direction is a first width after second printing on a second printing medium whose width in the first direction is a second width smaller than the first width, a printing apparatus controls a printing unit to conduct a first preliminary ejection on a printing medium whose width in the first direction is equal to or larger than the first width after the second printing and before the first printing.

### CROSS-REFERENCE TO PRIORITY APPLICATION

This application claims the benefit of Japanese Patent Application No. 2024-114668, filed Jul. 18, 2024, which is hereby incorporated by reference herein in its entirety.

### BACKGROUND

### Field of the Technology

The present disclosure relates to a printing apparatus, a control method and a storage medium.

### Description of the Related Art

In a printing apparatus, there is a case where an ejection defect of a printing head is generated because water, a solvent, or the like which is a solvent component of an ink evaporates from nozzles of the printing head and thickens while the printing of an image is not conducted. In order to suppress such an ejection defect, a sheet preliminary ejection of ejecting the ink thickened in the nozzles onto a printing medium is conducted.

Japanese Patent Laid-Open No. 2006-76247 discloses a technique of conducting a preliminary ejection which does not contribute to the printing of an image on a printing medium at random from nozzles of a printing head to such an extent that is less likely to affect the quality of an image.

### SUMMARY

A printing apparatus according to one aspect of the present disclosure comprises: a printing unit which prints images on a plurality of types of printing media having different widths in a first direction by ejecting an ink from a plurality of nozzles arrayed in the first direction; and a control unit which controls the printing unit to conduct a preliminary ejection of ejecting the ink which does not contribute to the printing of an image from the plurality of nozzles onto the printing media in order to maintain an appropriate ejection state of the plurality of nozzles, wherein in a case of conducting first printing on a first printing medium whose width in the first direction is a first width after second printing on a second printing medium whose width in the first direction is a second width smaller than the first width, the control unit controls the printing unit to conduct a first preliminary ejection on a printing medium whose width in the first direction is equal to or larger than the first width after the second printing and before the first printing.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are diagrams showing an overview of an entire printing apparatus;

FIGS. 2A and 2B are diagrams showing an overview of a printing head;

FIGS. 3A and 3B are diagrams showing an overview of printing chips and printing nozzles;

FIG. 4 is a diagram showing an overview of control of the printing apparatus;

FIGS. 5A and 5B are conceptual diagrams of unused nozzle regions;

FIG. 6 is a diagram showing a concept of a waste sheet preliminary ejection operation;

FIG. 7 is a flowchart showing a flow of processing of the entire waste sheet preliminary ejection operation;

FIG. 8 is a flowchart showing a detailed flow of processing of determination on insertion of a waste sheet preliminary ejection operation (flag 1);

FIGS. 9A to 9D are diagrams showing specific examples of the determination on insertion of a waste sheet preliminary ejection operation (flag 1);

FIG. 10 is a flowchart showing a detailed flow of processing of determination on insertion of a waste sheet preliminary ejection operation (flag 2);

FIGS. 11A and 11B are diagrams showing specific examples of the determination on insertion of a waste sheet preliminary ejection operation (flag 2);

FIGS. 12A to 12C are diagrams for explaining modifications of the number of waste sheet preliminary ejections; and

FIGS. 13A and 13B are diagrams for explaining modifications of the number of waste sheet preliminary ejections.

### DESCRIPTION OF THE EMBODIMENTS

Meanwhile, there is a case where a printing apparatus continuously conducts printing operations on printing media having different widths such as, for example, continuously conducting printing on 100 sheets of a printing medium of A4 size and subsequently continuously conducting printing on 3 sheets of a printing medium of B3 size. In the conventional methods for conducting preliminary ejection, in the case of printing an image on a printing medium of B3, there is a case where preliminary ejection is not actually executed on even nozzles on which the preliminary ejection should be executed, and there is a possibility that this leads to an ejection defect.

The present disclosure provides a technique of suppressing an ejection defect of nozzles even in the case of continuously conducting printing operations on a plurality of types of printing media having different widths.

Hereinafter, modes for carrying out the technique of the present disclosure will be described in detail with reference to the drawings. Note that the following present embodiments are not intended to limit the technique of the present disclosure according to claims. All the combinations of features described in the embodiments are not necessarily essential as solutions of the technique of the present disclosure, and a plurality of features may be combined as desired. Note that the same configurations are denoted by the same signs to be described. In addition, each step in flowcharts is described with “S” attached in front.

### First Embodiment

In the present embodiment, a printing apparatus using a line-type printing head of inkjet system will be described as an example. The printing apparatus is assumed to be a single-path printing apparatus using cut paper.

### <Printing Apparatus>

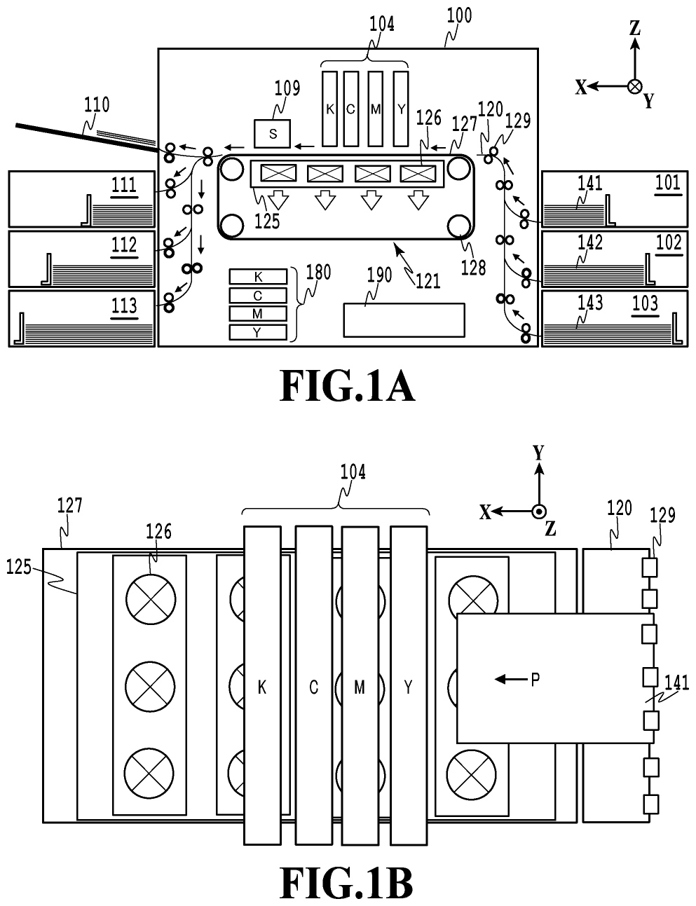

FIGS. 1A and 1B are schematic views showing an example of an internal configuration of the printing apparatus according to the present embodiment. FIG. 1A is a side view of the entire printing apparatus. Inside the printing apparatus, units, that is, feed units 101 to 103, a printing unit 100, and discharge units 110 to 113 are included. The feed units 101 to 103 are units which store and feed cut printing media. In the feed units 101 to 103, printing media of any sizes and materials can be set separately. For example, in the feed unit 101, a printing medium 141, that is, coated paper of A4 size (210 mm×297 mm) can be set. In the feed unit 102, a printing medium 142, that is, plain paper of A3 size (297 mm×420 mm) can be set. In the feed unit 103, a printing medium 143, that is, fine-art paper of JIS B3 size (364 mm×515 mm) can be set. Note that the feed units 101 to 103 can continuously feed printing media of different sizes and types like printing media 141→142→143→141→142→143 to be printed by the printing unit 100. The discharge units 111 to 113 can also allow the printing media to be aligned and discharged in accordance with the respective different sizes and types.

FIG. 1B is a top view of main units of the printing unit 100. The printing unit 100 is a unit which prints images on the printing media by using the printing heads 104. The printing media 141 to 143 are fed by a frictional force of a plurality of conveyance rollers 129 disposed along a guide 120, and then are passed to and conveyed by a print belt unit 121 (hereinafter, PBU) below the printing heads 104. That is, it can be said that the printing heads 104 print images on a plurality of different types of printing media having different widths in a Y direction like the printing media 141, 142, and 143, for example, by ejecting inks from a plurality of printing nozzles arrayed in the Y direction, which will be described in detail later. The PBU 121 includes driver rollers 128, a print belt 127, and a negative-pressure generating unit 125. The negative-pressure generating unit 125 includes four fan units arranged in a X direction which is a conveyance direction of the printing media, where each fan unit includes three suction fans 126 arranged in the Y direction which is a direction intersecting the conveyance direction of the printing media. In addition, in the print belt 127, a large number of air holes (φ=1 mm) for passing the air from the front surface to the back surface of the belt are opened. The inside of the negative-pressure generating unit 125 is depressurized by 300 Pa to 500 Pa relative to the atmospheric pressure by the rotation operation of the suction fans 126. The negative-pressure generating unit 125 communicates with the large number of air holes of the print belt 127, and can convey the printing media 141 to 143 in the state of being sucked and fixed on the print belt 127 in a Z direction. In this way, images can be printed while an appropriate interval is maintained between the printing media 141 to 143 and the printing heads 104 (a head-sheet interval=about 1.3 mm). Note that it can be said that the printing media 141 to 143 are conveyed in a direction along the X direction in FIG. 1B, which intersects a printing nozzle array direction along the Y direction in FIG. 1B, which is an array direction of the plurality of printing nozzles 13 formed in the printing heads 104, which will be described in detail later.

Referring back to FIG. 1A, the printing heads 104 will be described. The printing heads 104 are line-type printing heads in which nozzle arrays are formed along the widths of the printing media to cover the maximum width of the printing media. The present embodiment is assumed to include four printing heads corresponding to four colors of K (black), C (cyan), M (magenta), and Y (yellow). That is, the present embodiment is assumed to include a printing head capable of ejecting a black ink, a printing head capable of ejecting a cyan ink, a printing head capable of ejecting a magenta ink, and a printing head capable of ejecting a yellow ink. Note that the number of colors and the number of printing heads are not limited to four. Although as the inkjet system, a thermal system using heat generating elements is described as an example in the present embodiment, a system using piezoelectric elements, a system using electrostatic elements, a system using MEMS elements, or the like can be employed instead. The inks of the respective colors are supplied from the respective ink tanks 180 to the printing heads 104 via ink tubes, which are not shown. In the standby state (printing start waiting state), the printing heads 104 are tightly closed with a cap, which is not illustrated, in a cap closed state, and the cap is opened at the time of starting the printing, and then the cap is closed again at the time of ending the printing. In addition, by reducing the pressure inside the cap in the cap closed state, the inks can be sucked and recovered through the nozzles of the printing heads 104. The waste inks used for recovering the reliability of the printing heads 104 are discharged to a waste ink tank 190 via waste ink tubes which are not shown. In addition, the scanner unit 109 can be used for image detection, image correction, and the like by scanning a printed product printed by the printing heads 104. The discharge units 110 to 113 are units for discharging printed printing media while sorting the printing media into discharge trays for the respective groups, as necessary. The discharge unit 110 is an open tray in which the printing media of different sizes can be stacked in a mixed manner. The discharge units 111 to 113 are closed trays in each of which a printing medium of the same size can be stacked in an aligned manner.

### <Printing Head>

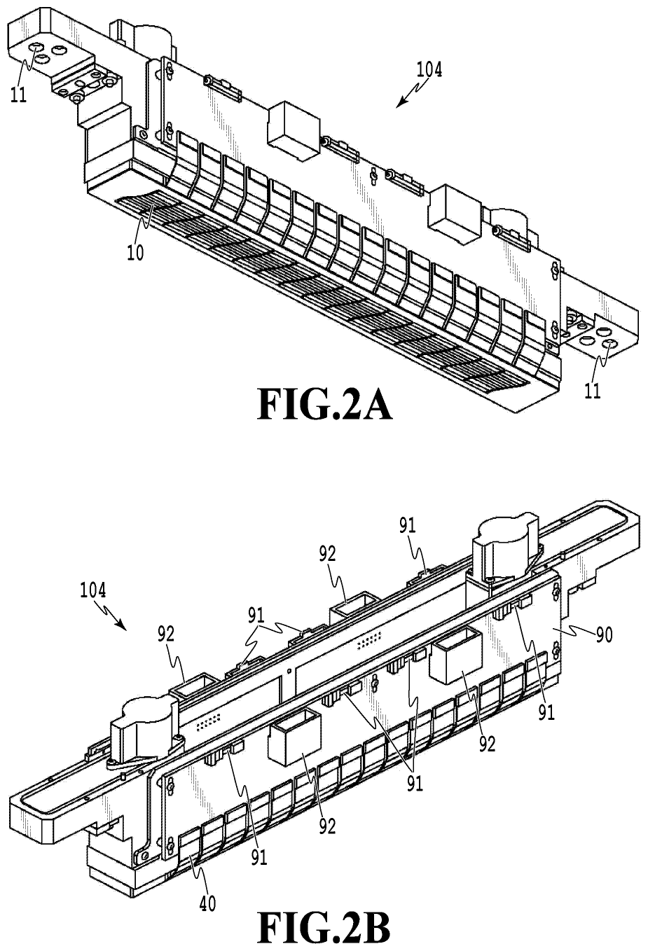

FIGS. 2A and 2B are schematic views of the printing head. FIG. 2A shows the printing head as viewed from below, and FIG. 2B shows the printing head as viewed from above. As shown in FIG. 2A, the printing head 104 is a chip-connected-type line head in which a plurality of printing chips 10 are arranged side by side. Between the plurality of printing chips 10 arranged side by side, seams are generated. In order to minimize the size of the printing head 104 while effectively using all the nozzles incorporated in the printing chips 10, in the present embodiment, the printing chips 10 having a parallelogram shape is employed. As the printing chips 10, those having various shapes such as a rectangular shape and trapezoidal shape may be employed. The connection units 11 provided in both end portions of the printing head 104 are connected to an ink supply mechanism, which are not shown, of the printing apparatus. This allows the ink of each color to be supplied from the ink supply mechanism to the printing head 104, and the ink which has passed through inside the printing head 104 is recovered to the ink supply mechanism. In this way, the ink can be circulated via passages of the ink supply mechanism and passages of the printing head 104. As shown in FIG. 2B, the printing head 104 includes signal input terminals 91 and power supply terminals 92 which are electrically connected to the printing chips 10 and the flexible circuit boards 40 via electric wiring boards 90. The signal input terminals 91 and the power supply terminals 92 are electrically connected to a printing control unit 215A of the printing apparatus, which will be described later, and supply drive signals and electric power required for ejection to the printing chip 10. By concentrating the wiring by using an electric circuit inside the electric wiring board 90, the numbers of the signal input terminals 91 and the power supply terminals 92 can be reduced as compared with the number of the printing chips 10. In this way, only a small number of electric connection units which need to be removed at the time of attaching the printing head 104 to the printing unit 100 in FIGS. 1A and 1B or replacing the printing head 104 is required. Note that although an ink circulation-type printing head is used in the present embodiment, an ink consumption-type printing head which does not include an ink circulation mechanism may also be used.

### <Printing Chip and Printing Nozzle>

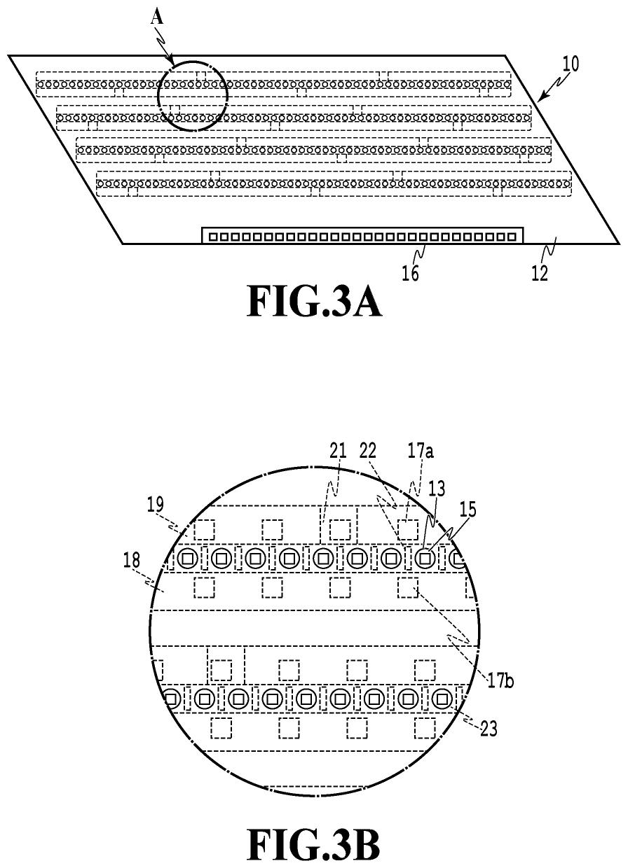

FIGS. 3A and 3B are diagrams showing an overview of the printing chip 10 and the printing nozzles 13. FIG. 3A shows a plan view of a surface of the printing chip 10 on which the printing nozzles 13 are formed, and FIG. 3B shows an enlarged view of a portion indicated by a bounding outline A in FIG. 3A.

As shown in FIG. 3A, in the nozzle forming member 12 of the printing chip 10, four printing nozzle arrays are formed. Note that hereinafter, a direction in which the printing nozzle array in which a plurality of the printing nozzles 13 are arrayed extends is referred to as a “printing nozzle array direction”.

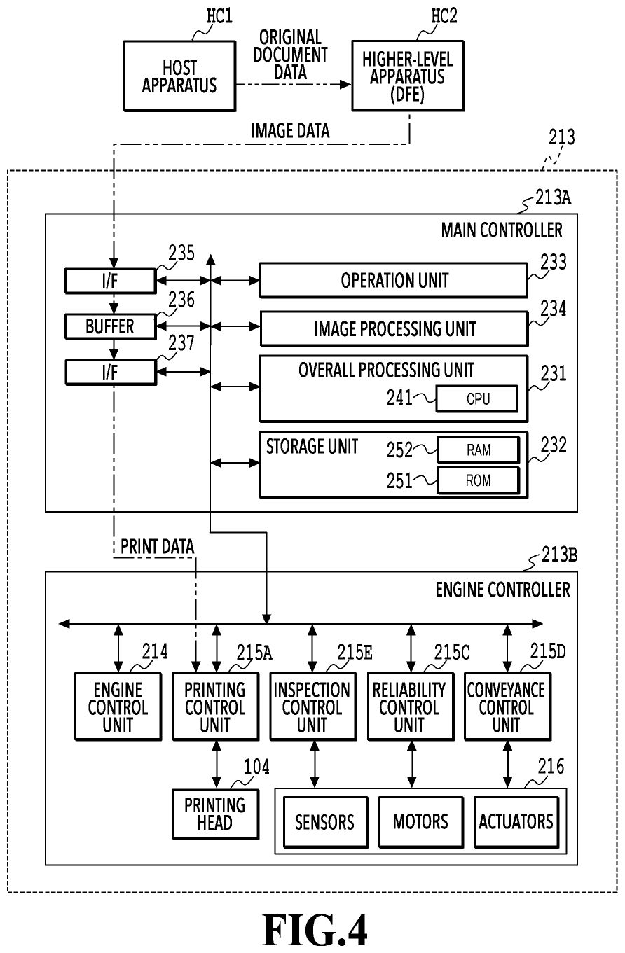

As shown in FIG. 3B, a printing element 15, which is a heat generating element for foaming the liquid with a thermal energy, is disposed at a position corresponding to each printing nozzle 13. A pressure chamber 23 including the printing element 15 inside is sectioned by a partition wall 22. The printing element 15 is electrically connected to a terminal 16 in FIG. 3A by means of an electric wire, which is not shown, provided in the printing chip 10. The printing element 15 generates heat based on a pulse signal outputted from the printing control unit 215A shown in FIG. 4 to boil the liquid. By the force of foaming by this boiling, the ink is ejected from the printing nozzle 13.

As shown in FIG. 3B, a liquid supply passage 18 and a liquid recovery passage 19 extend respectively on one side and the other side along each printing nozzle array. The liquid supply passage 18 and the liquid recovery passage 19 are flow passages which are provided in the printing chip 10 and extend in the printing nozzle array direction, and communicate with the printing nozzle 13 via a supply port 17a and a recovery port 17b, respectively. A plurality of the supply ports 17a, which are through-holes penetrating the board, are provided to form a supply port array along the array of the printing nozzles 13, and similarly, a plurality of the recovery ports 17b, which penetrate the board, also form a recovery port array along the printing nozzle array. The liquid supply passage 18, which is a common flow passage for supplying the liquid to the supply port array, is formed along the supply port array, and the liquid recovery passage 19, which is a common flow passage for recovering the liquid from the recovery port array, is formed along the recovery port array.

### <Control Unit>

FIG. 4 is a diagram showing an overview of controls of the printing apparatus included in a printing system. A control unit 213 is communicably connected to a higher-level apparatus (DFE) HC2. In addition, the higher-level apparatus HC2 is communicably connected to a host apparatus HC1. The host apparatus HC1 generates or stores original document data based on which a printing image is generated. The original document data is generated in a format of an electronic file such as a document file or an image file, for example. The original document data is transmitted to the higher-level apparatus HC2. The higher-level apparatus HC2 converts the received original document data to a data format that can be used in the control unit 213. This is RGB data represented by RGB 8 bit, for example. The converted data is transmitted from the higher-level apparatus HC2 to the control unit 213 as image data. Note that to the image data, printing instruction information which designates the type of a printing target printing medium, the size of the printing medium such as A4, A3, or B3, and the like is added. The control unit 213 starts the printing operation based on the received image data to which the printing instruction information has been added.

In the present embodiment, the control unit 213 is broadly divided into a main controller 213A and an engine controller 213B. The main controller 213A includes an overall processing unit 231, a storage unit 232, an operation unit 233, an image processing unit 234, a communication I/F (interface) 235, a buffer 236, and a communication I/F 237. The overall processing unit 231 includes a processor such as a CPU 241, executes programs stored in a ROM 251 of the storage unit 232, and controls the entire main controller 213A. The storage unit 232 includes storage devices such as a RAM 252, the ROM 251, a hard disk, and an SSD, and stores the programs to be executed by the overall processing unit 231 including the CPU 241, and data, and also provides a work area to the overall processing unit 231. The operation unit 233 is input devices such as a touch panel, a keyboard, and a mouse, for example, and receives instructions of the user.

The image processing unit 234 is an electronic circuit including an image processor (FPGA or ASIC), for example. The buffer 236 includes a RAM, a hard disk, or an SSD, for example. The communication I/F 235 conducts communications with the higher-level apparatus HC2. The communication I/F 237 conducts communications with the engine controller 213B.

In FIG. 4, an arrow of a two-dot-dashed line indicates the flow of processing of image data. Image data received from the higher-level apparatus HC2 via the communication I/F 235 is accumulated in the buffer 236. The image processing unit 234 reads the image data from the buffer 236, conducts predetermined image processing on the image data thus read, and stores the image data in the buffer 236 again. The image data after the image processing which is stored in the buffer 236 is transmitted from the communication I/F 237 to the engine controller 213B as print data to be used by a printing engine.

The engine controller 213B includes an engine control unit 214 and control units 215A to 215E, and acquires results of detections and controls drives of the sensor group and actuator group 216 included in the printing system. Each control unit 215A to 215E includes a processor such as a CPU, a storage device such as a RAM or a ROM, and an interface with an external device. Note that this division of the control unit is an example, and part of the control may be executed by a plurality of further divided control units, or a plurality of control units may be integrated such that a single control unit conducts these control contends.

The engine control unit 214 controls the entire engine controller 213B. The printing control unit 215A converts print data received from the main controller 213A to a data format such as binary data which is suitable for the drive of the printing heads 104. The printing control unit 215A controls the ejection of the printing heads 104. The reliability control unit 215C controls a drive mechanism which moves the printing heads 104 between an image printing position and a recovery position. The conveyance control unit 215D conveys printing media by controlling the feed units 101 to 103, the discharge units 110 to 113, the PBU 121, and the like. The inspection control unit 215E controls the scanner unit 109 as an image inspection unit. Note that the sensor group among the sensor group and actuator group 216 includes a sensor for detecting the positions and speeds of movable units, a sensor for detecting a temperature, imaging devices, and the like. The actuator group includes a motor, an electromagnetic solenoid, an electromagnetic valve, and the like.

### <Concept of Unused Nozzle Region>

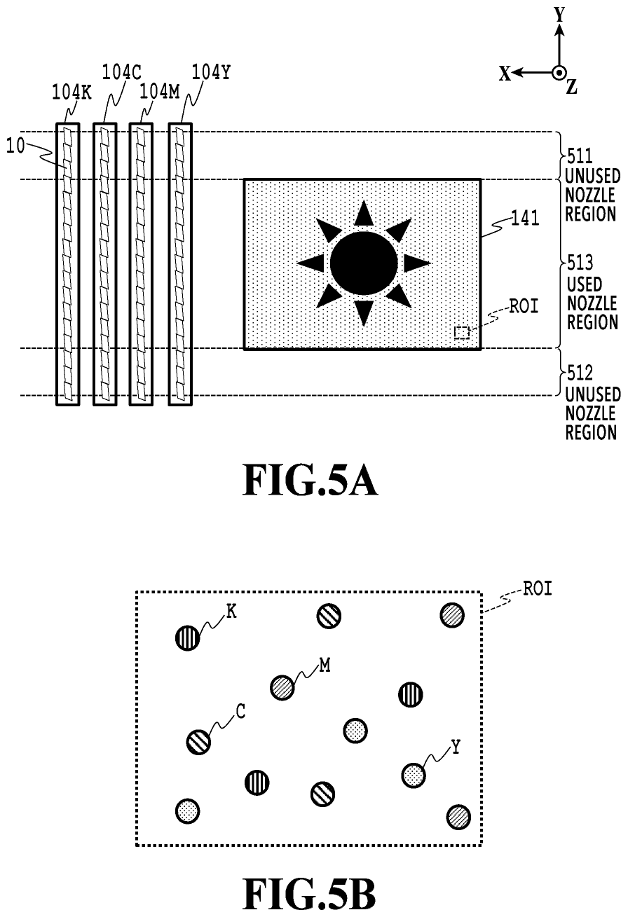

FIGS. 5A and 5B are diagrams for explaining a concept of unused nozzle regions in the present embodiment.

FIG. 5A is a conceptual diagram of execution of single path printing on the printing medium 141 by using the printing heads 104. The single path printing is printing by one scanning. An image is printed in the state where the respective centers of the printing heads 104 and the printing medium 141 are aligned at the same position in the Y direction. As shown in FIG. 5A, in both ends of the printing heads 104, unused nozzle regions 511, 512 are generated. The unused nozzle regions 511, 512 are nozzle regions composed of nozzles which are not used in either of the printing of an image and a sheet preliminary ejection operation which will be described later. As described in FIG. 1B, the vicinities of the unused nozzle regions 511, 512 are reduced in pressure by the suction fans 126 in the negative-pressure generating unit 125. That is, the unused nozzle regions 511, 512 are in a disadvantageous situation where the nozzles in the unused nozzle regions 511, 512 are likely to be dried by air flows generated by the reduction in pressure as compared with the nozzles in a used nozzle region 513 where the printing medium 141 is present, and are likely to cause an ejection defect. The used nozzle region 513 is a nozzle region composed of nozzles which are used in the printing of an image. Moreover, in the present embodiment, regarding the used nozzle region 513 for the printing medium 141, the sheet preliminary ejection operation is executed. The sheet preliminary ejection operation is an operation of ejecting a small number of ink droplets on a sheet to such an extent that the ink droplets cannot be visually recognized in order to appropriately maintain the ejection state of the nozzles and prevent an ejection defect of the nozzles. Note that the sheet preliminary ejection operation is also referred to as a sheet preliminary ejection. Here, one droplet per nozzle is shot onto the printing medium 141 for each of the printing heads 104 of KCMY colors.

FIG. 5B is a conceptual diagram of the sheet preliminary ejection, and is a diagram in which a sheet preliminary ejection region ROI in FIG. 5A is expanded. Droplets of the inks of the respective KCMY colors are ejected at set appropriate intervals to achieve a reduction of ejection defects while suppressing visibility by eyes.

As described above, the unused nozzle regions 511, 512 are disadvantageous in the following two points as compared with the used nozzle region 513. The first point is that the unused nozzle regions 511, 512 are likely to be directly affected and dried by the air flows of the suction fans, and the second point that the unused nozzle regions 511, 512 are not used for printing an image and periodical preliminary ejection cannot be conducted by means of the sheet preliminary ejection. Note that although the description is made by using the printing medium 141 (A4 size, 210 mm×297 mm) as an example here, the size of the printing medium is not limited to the above-described size.

### <Waste Sheet Preliminary Ejection Pattern>

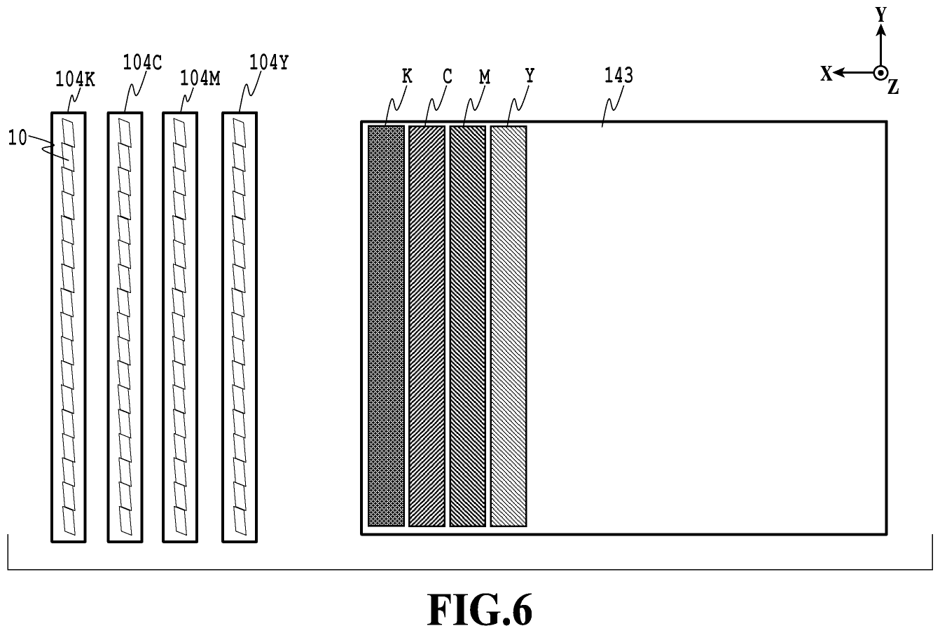

FIG. 6 is a conceptual diagram of a waste sheet preliminary ejection pattern. The waste sheet preliminary ejection is defined as a preliminary ejection pattern to be inserted in a waste sheet in order to appropriately maintain the ejection state of the nozzles in unused nozzle regions and improve ejection defects of the nozzles. Note that the waste sheet preliminary ejection pattern is also referred to as a preliminary ejection pattern. The waste sheet is a printing medium which is not used in printing an image and wasted. By inserting the waste sheet preliminary ejection at a necessary timing during the printing of an image, ejection defects in the aforementioned unused nozzle regions are improved.

Specifically, it is assumed that the waste sheet preliminary ejection pattern is composed of color bars of the respective KCMY colors, and is formed by ejecting a minimum number of droplets necessary for recovery for the nozzles of each color on the surface of a waste sheet in the X direction, which intersects the width direction of a printing medium. That is, a preliminary ejection pattern of each of the cyan ink, the magenta ink, the yellow ink, and the black ink is printed on a waste sheet, which is a printing medium not used in printing an image. In the present embodiment, it is assumed that 100 droplets are ejected per nozzle. It is assumed that the waste sheet preliminary ejection pattern is printed up to the maximum printing regions on the end portions of the medium in the Y direction. It is assumed that the maximum printing region is from the end portion to a 2-mm position on the inner side in consideration of an error in conveyance of the printing medium, and the like. For example, in the case where the printing medium 143 on which to print an image at this time is of JIS B3 size (364 mm×515 mm), a waste sheet preliminary ejection pattern having a size of 360 mm in the Y direction is printed on the printing medium 143.

### <Features in Present Embodiment>

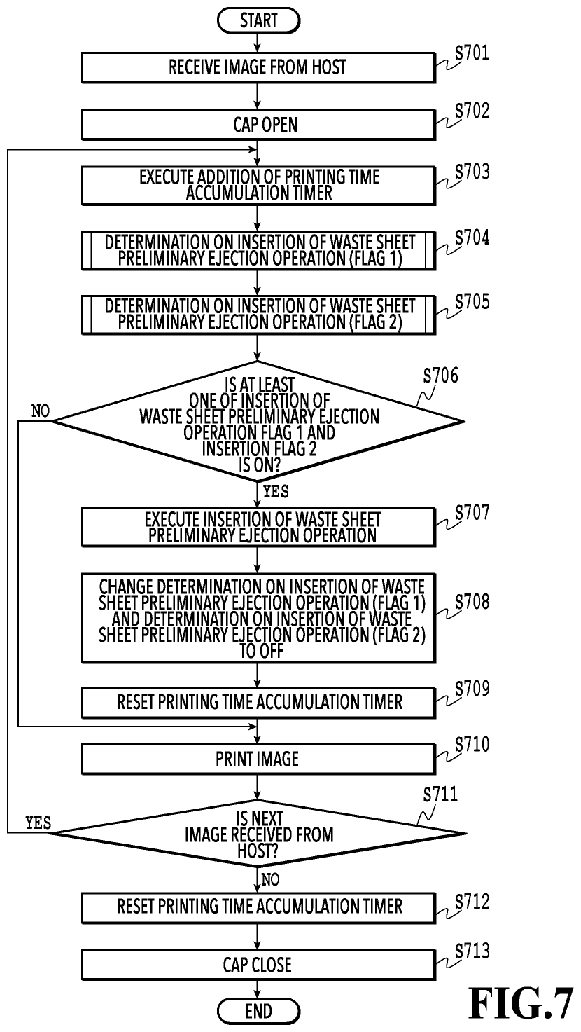

FIG. 7 is a flowchart showing a flow of processing of determination on an insertion of waste sheet preliminary ejection in the present embodiment. Each processing from S701 to S713 is conducted by the CPU of the overall processing unit 231 developing programs held in the ROM of the storage unit 232 on the RAM, and executing the developed programs in cooperation with the printing control unit 215A, the conveyance control unit 215D, and the like as appropriate. Hereinafter, the processing of determination on insertion of a waste sheet preliminary ejection operation, which is a feature of the present embodiment, will be described in detail with reference to the drawings as appropriate. Note that for simplifying the description, the description of an execution main body in each step is omitted below.

First, in S701, image data is inputted from the host apparatus HC1 to the communication I/F 235 through the higher-level apparatus HC2. That is, in this input of image data, regarding a printing medium on which an image which is a user image based on the image data is to be printed, printing information indicating the size and the like of the printing medium, such as the type of the printing medium and the width of the printing medium, is also inputted. Note that the image data and printing information thus inputted are stored in the RAM 252 of the storage unit 232 or the like.

Next, in S702, the cap of the printing heads 104 is opened. Specifically, in accordance with an instruction from the overall processing unit 231, the reliability control unit 215C separates the nozzle faces of the printing heads 104, which have been in tight contact with the cap, from the cap, and moves the nozzle faces of the printing heads 104 to a position above the PBU 121, which is the printing position. This operation brings about standby in a printable state. Note that this operation is referred to as cap open.

In S703, the addition of a printing time accumulation timer is executed. The longer the accumulated elapsed time from the cap open, the higher the risk of an ejection defect of the nozzles. For this reason, this processing is executed to measure this time. In the present embodiment, it is assumed that the printing time accumulation timer measures, by seconds, the accumulated elapsed time from when the cap is opened and the printing of an image on the first sheet of the printing medium is started. Next, in S704 and S705, the processing of determining insertion of a waste sheet preliminary ejection operation is executed. Although a specific content of the processing will be described later, two independent insertion determination sequences are executed as determination on insertion of a waste sheet preliminary ejection operation (flag 1) and determination on insertion of a waste sheet preliminary ejection operation (flag 2).

In S706, it is checked whether at least one of the determination on insertion of a waste sheet preliminary ejection operation (flag 1) and the determination on insertion of a waste sheet preliminary ejection operation (flag 2) is ON (valid). If it is detected that both of the determination on insertion of a waste sheet preliminary ejection operation (flag 1) and the determination on insertion of a waste sheet preliminary ejection operation (flag 2) are not ON (NO in S706), the processing proceeds to S710. On the other hand, if it is detected that at least one of the determination on insertion of a waste sheet preliminary ejection operation (flag 1) or the determination on insertion of a waste sheet preliminary ejection operation (flag 2) is ON (YES in S706), the processing proceeds to S707.

In S707, insertion of a waste sheet preliminary ejection operation is executed. That is, sheet preliminary ejection of ejecting the inks from the nozzles of the printing heads onto a printing medium having a larger width than the width of a printing medium on which an image is to be printed in S710 described later is executed. Note that the printing information indicating the width of the printing medium on which the waste sheet preliminary ejection operation has been executed is stored in the RAM 252 or the like of the storage unit 232. In S708, as post-processing after the insertion of waste sheet preliminary ejection, the determination on insertion of a waste sheet preliminary ejection operation (flag 1) and the determination on insertion of a waste sheet preliminary ejection operation (flag 2) are changed to OFF. In S709, the printing time accumulation timer is reset. This is because the ejection defect state of the unused nozzle regions is recovered by executing the insertion of a waste sheet preliminary ejection operation. Note that it is assumed that the determinations on insertion of a waste sheet preliminary ejection operation (flag 1) and (flag 2) and the printing time accumulation timer are developed on the RAM of the storage unit 232.

In S710, a printing operation of an image is conducted. Specifically, an image based on the image data received from the host apparatus HC1 in S701 is printed on a printing medium having a designated size. Note that if both of the determination on insertion of a waste sheet preliminary ejection operation (flag 1) and the determination on insertion of a waste sheet preliminary ejection operation (flag 2) are OFF (invalid) in S706, the processing proceeds to S710. The processing proceeds to S710 without executing the processing from S707 to S709, that is, without executing the insertion of a waste sheet preliminary ejection operation. Then, in S710, the image is printed.

In S711, it is determined whether image data has been inputted from the host apparatus HC1 to the communication I/F 235 through the higher-level apparatus HC2. That is, it is checked whether image data to be continuously printed is present, and it is checked whether to receive the next image from the host. If it is determined that image data to be continuously printed is present, and that the next image has been received from the host (YES in S711), the processing is returned to S703, and the addition of the printing time accumulation timer is continued. Here, it is assumed that the printing time accumulation timer measures, by seconds, the accumulated elapsed time from when the printing of the image on the next first sheet of the printing medium after the insertion of the waste sheet preliminary ejection pattern is started. On the other hand, if it is determined that an image to be continuously printed is not present, and that the next image has not been received from the host (NO in S711), the processing proceeds to S712.

In S712, the printing time accumulation timer is reset. In S713, the cap closing operation on the printing heads 104 is executed. In the present embodiment, the reason why the printing time accumulation timer is reset is that the ejection defect attributable to the thickening of the inks or the like in the nozzles is recovered due to a wetting effect or an ink circulation effect in the cap by the cap closing operation. On the other hand, in the case where a cap closed time is a short time, there is a possibility that the wetting effect or the ink circulation effect in the cap is not obtained, it is also possible not to reset the printing time accumulation timer in the cap closing operation.

### <Determination on Insertion of Waste Sheet Preliminary Ejection Operation (Flag 1)>

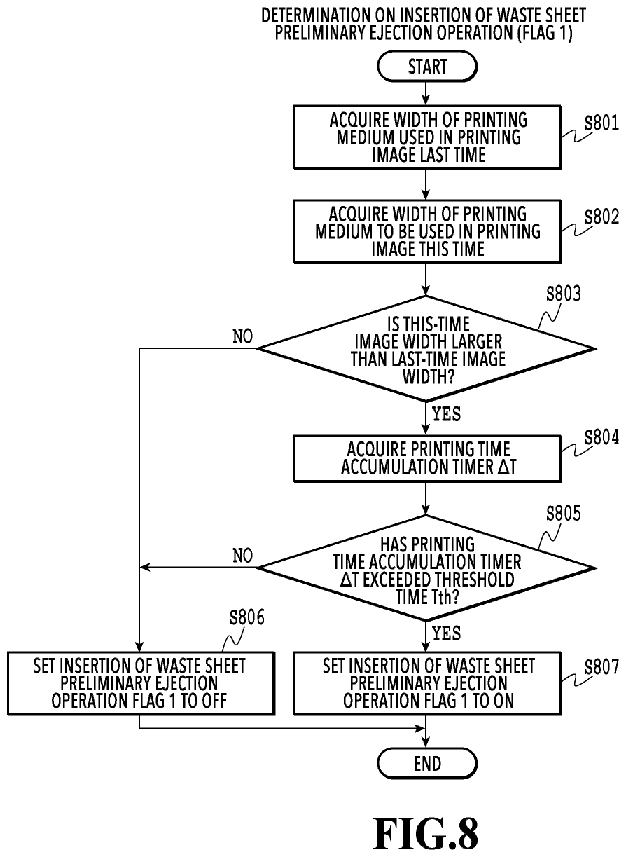

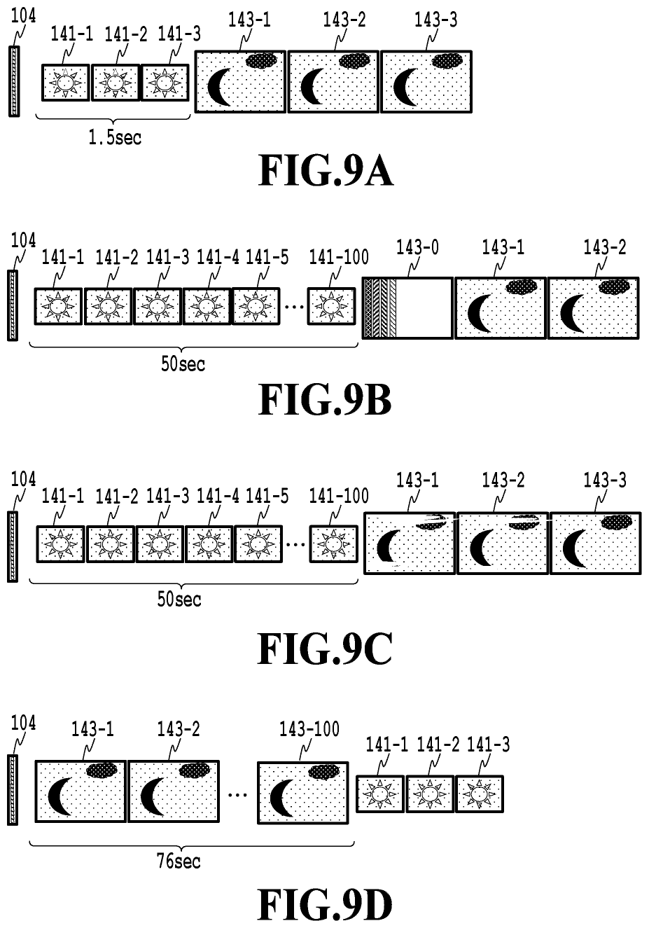

FIG. 8 is a flowchart showing a detailed flow of the processing of the determination on insertion of a waste sheet preliminary ejection operation (flag 1). FIGS. 9A to 9D are conceptual diagrams for explaining a specific example of insertion of a waste sheet preliminary ejection operation (flag 1). The determination on insertion of a waste sheet preliminary ejection operation (flag 1) will be described in detail by using FIG. 8 and FIGS. 9A to 9D as appropriate.

In S801, the conveyance control unit 215D acquires the width of the printing medium used in printing the image last time (hereinafter, referred to as the “last-time image width”). In S802, the conveyance control unit 215D similarly acquires the width of the printing medium to be used in printing the image this time (hereinafter, referred to as the “this-time image width”). The purpose of this is to simply determine the unused nozzle regions by acquiring the widths of the printing media. FIG. 9A is a conceptual diagram in which immediately after the cap open, an image is printed on 3 sheets of the printing medium 141 (A4 size, 210 mm×297 mm), and then an image is printed on 3 sheets of the printing medium 143 (JIS B3 size, 364 mm×515 mm).

In FIG. 9A, at the time when the printing on the printing medium 141-3 is completed, since the printing medium used in the printing operation last time is of A4 size, the width is 210 mm. That is, in S801, 210 mm is acquired as the “last-time image width”. Then, since the printing medium 143-1 to be used in the next printing operation is of JIS B3 size, the width is 364 mm. That is, in S802, 364 mm is acquired as the “this-time image width”.

Referring back to FIG. 8, in S803, it is determined whether the this-time image width is larger than the last-time image width. If it is determined that the this-time image width is larger than the last-time image width, the processing proceeds to S804. S804 will be described later. If it is determined the this-time image width is equal to the last-time image width, or smaller than the last-time image width, unused nozzle regions are not generated in switching the size of the printing medium. For this reason, the insertion of a waste sheet preliminary ejection operation is unnecessary. In this case, the determination is NO in S803, the processing proceeds to S806. In S806, the insertion of a waste sheet preliminary ejection operation flag 1 is set to OFF. After the processing of S806 ends, the flow shown in FIG. 8 is ended.

FIG. 9D is a conceptual diagram corresponding to the case where the determination is NO in the branch of S803 in the flowchart of FIG. 8. Here, after an image is printed on 100 sheets of the printing medium 143 of JIS B3 size, an image is printed on 3 sheets of the printing medium 141 of A4 size. At the time when the printing on the printing medium 143-100 is completed, since the printing medium on which the image was printed last time is of JIS B3 size, the “last-time image width” is 364 mm. On the other hand, since the printing medium on which the image will be printed next is of A4 size, the “this-time image width” is 210 mm. At the time when the printing on the printing medium 143-100 is completed, the region of JIS B3 size is in the state where an ejection defect has not been generated because the sheet preliminary ejection operation has been executed as described in FIGS. 5A and 5B. For this reason, it is unnecessary to execute the waste sheet preliminary ejection operation for the nozzles corresponding to the width of the printing medium on which the image will be printed next.

Referring back to FIG. 8, in S804, a value of the printing time accumulation timer is acquired. The printing time accumulation timer stores, by seconds, printing time accumulation from when the cap of the printing heads 104 is opened and the printing of the image on the first sheet is started. In FIG. 9A, the printing time accumulation timer at the time when the printing of the image on the printing medium 141-3 of A4 size is completed is 1.5 sec. The detail of 1.5 sec is such that a value obtained by dividing 337 mm, which is a length obtained by adding the length 297 mm of A4 size and the interval 40 mm between the sheets of the printing medium, by the conveyance speed 675 mm/sec of the printing medium is 0.5 sec, and the accumulation value for 3 sheets is 1.5 sec.

Referring back to FIG. 8, in S805, it is determined whether the printing time accumulation timer ΔT has exceeded a threshold time Tth. The purpose of this is because even in the case where unused nozzle regions are present in S803, if the unused time is shorter than the threshold time Tth, the unused nozzle regions does not lead to an ejection defect and are thus acceptable. Although the threshold time Tth can be determined based on an image quality target, an ink performance, and the like as appropriate, the threshold time Tth here is set to 30 sec. If it is determined that the printing time accumulation timer ΔT has not exceeded the threshold time Tth (NO in S805), the processing proceeds to S806. On the other hand, if it is determined that the printing time accumulation timer ΔT has exceeded the threshold time Tth (YES in S805), since an ejection defect of the unused nozzle regions is not acceptable, the processing proceeds to S807. In S807, the insertion of a waste sheet preliminary ejection operation flag 1 is set to ON. After the processing of S807 has ended, the flow shown in FIG. 8 is ended.

FIG. 9A is a conceptual diagram corresponding to the case where it is determined that the printing time accumulation timer ΔT has not exceeded the threshold time Tth (NO in S805) in the branch of S805 in the flowchart of FIG. 8. FIG. 9B is a conceptual diagram corresponding to the case where it is determined that the printing time accumulation timer ΔT has exceeded the threshold time Tth (YES in S805) in the branch of S805.

In FIG. 9A, at the time when the printing on the printing medium 141-3 is completed, the printing time accumulation timer is 1.5 sec, which is equal to or less than 30 sec of the threshold time Tth. For this reason, at the time of printing on the printing medium 143-1, although the width of the printing medium on which the image is printed this time is larger than the width of the printing medium on which the image was printed last time, it is unnecessary to conduct insertion of a waste sheet preliminary ejection operation. Hence, the insertion of a waste sheet preliminary ejection flag 1 is set to OFF.

In FIG. 9B, at the time when the printing on the printing medium 141-100 is completed, the printing time accumulation timer is 50 sec, which has exceeded 30 sec of the threshold time Tth. Moreover, the width of the printing medium on which the image is printed next is larger than the width of the printing medium on which the image was printed last time. This means that the nozzles to be used in the first printing on the printing medium 143 include the nozzles which have not been used for a certain period of time or longer besides the nozzles used in the second printing on the printing medium 141 conducted before the first printing. Hence, the insertion of a waste sheet preliminary ejection flag 1 is set to ON. Here, before the printing on the printing medium 143-1 is started, the printing medium 143-0 of JIS B3 size is inserted, and the waste sheet preliminary ejection operation is conducted on the printing medium 143-0. As a result, among the nozzles which can be used in the printing on the printing medium 143-1, in the nozzles included in the unused nozzle regions in the printing operation last time, generation of an ejection defect can be suppressed. That is, in the case of conducting the first printing on the printing medium 143 whose width in a first direction is a first width after the second printing on the printing medium 141 whose width in the first direction is a second width smaller than the first width, the printing heads 104 are controlled as described below. The printing heads 104 are controlled to conduct first preliminary ejection on the printing medium 143-0 whose width in the first direction is equal to or larger than the first width after the second printing (the printing medium 141-100) and before the first printing (the printing medium 143-1). In addition, it can also be said that at least one sheet of the printing medium 143-0 for conducting the first preliminary ejection is conveyed before the first sheet of the printing medium 143-1 in the first printing.

FIG. 9C is a conceptual diagram showing a comparative example of FIG. 9B. FIG. 9C shows the case where a condition that the width of the printing medium 143 to be printed this time is larger than the width of the printing medium 141 printed last time, and the printing time accumulation timer has exceeded the threshold time Tth is satisfied, but the waste sheet preliminary ejection operation is not inserted. This is a timing at which the size of a printing medium on which the image is printed is switched from A4 size to JIS B3 size. This drawing shows that an ejection defect has occurred in unused nozzles, which have not been used for the printing from the printing media 141-1 to 141-100, and a thin spot is generated in an image printed on the printing medium 143-1.

As described above, in the case where the width of the printing medium to be printed this time is larger than the width of the printing medium printed last time, and the printing time accumulation timer has exceeded the threshold time, the waste sheet preliminary ejection operation is executed by the determination on insertion of a waste sheet preliminary ejection operation (flag 1). However, the waste sheet preliminary ejection operation is executed on a printing medium having a width larger than the width of a printing medium to be printed this time. In this way, an ejection defect in nozzles included in the unused nozzle region in the printing operation last time can be suppressed.

### <Determination on Insertion of Waste Sheet Preliminary Ejection Operation (Flag 2)>

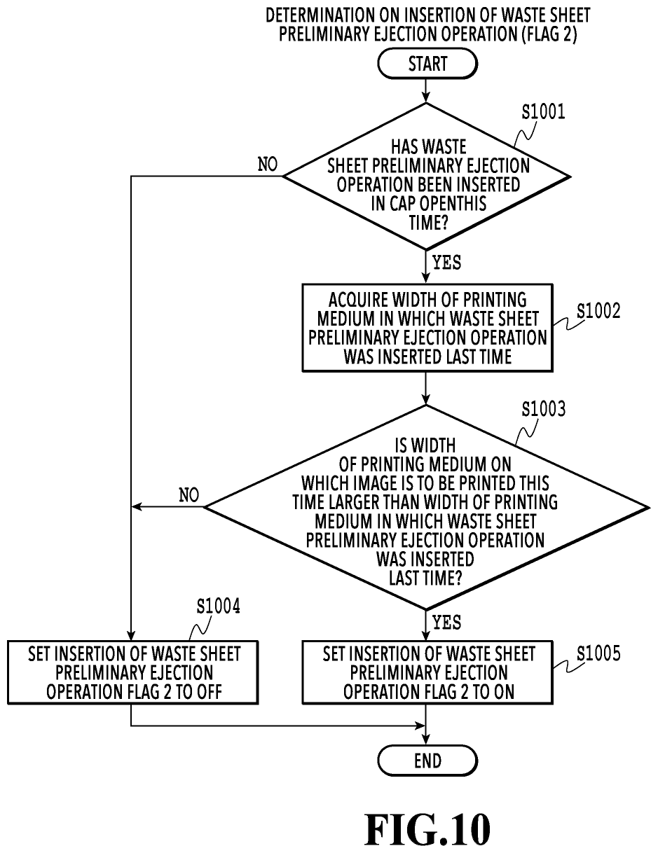

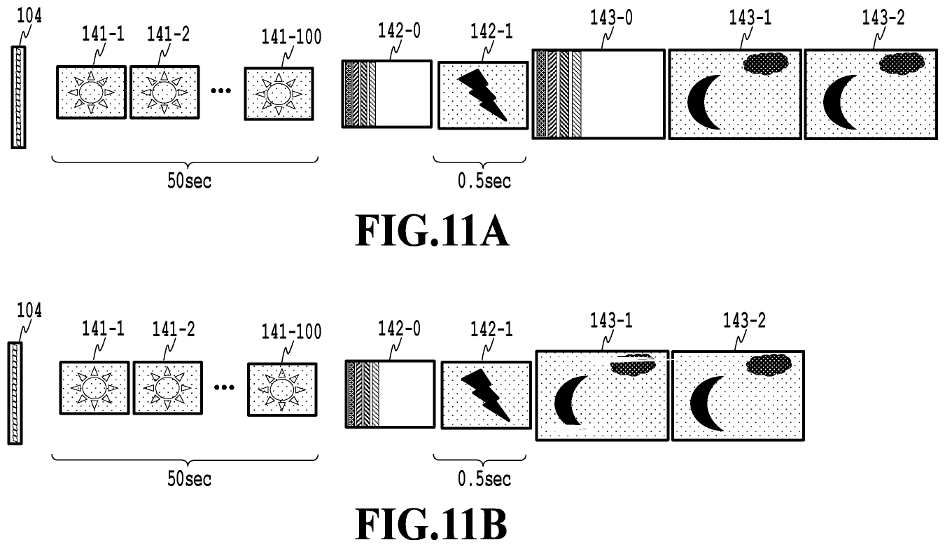

FIG. 10 is a flowchart showing a detailed flow of the processing of the determination on insertion of a waste sheet preliminary ejection operation (flag 2). FIGS. 11A and 11B are conceptual diagrams for explaining specific examples of the insertion of a waste sheet preliminary ejection operation (flag 2). The determination on insertion of a waste sheet preliminary ejection operation (flag 2) will be described in detail by using FIG. 10 as well as FIGS. 11A and 11B as appropriate.

The purpose of the determination on insertion of a waste sheet preliminary ejection operation (flag 2) is as follows. That is, this is a countermeasure for the case where the waste sheet preliminary ejection operation is not inserted in the case of printing images on printing media having N printing widths (N≥3) between the cap open to the cap close even under a condition that it is necessary to insert the waste sheet preliminary ejection operation.

In S1001, it is inspected whether the waste sheet preliminary ejection operation has been inserted in the cap open this time. If a result of inspection that the waste sheet preliminary ejection operation has not been inserted in the cap open this time is obtained (NO in S1001), the processing proceeds to S1004. In S1004, the insertion of a waste sheet preliminary ejection operation flag 2 is set to OFF. After the processing of S1004 has ended, the flow shown in FIG. 10 is ended. This means that the insertion of a waste sheet preliminary ejection operation by the determination on insertion of a waste sheet preliminary ejection operation (flag 2) is invoked (executed) only in the case where a waste sheet preliminary ejection operation has been inserted at least once in the cap open this time. If a result of inspection that a waste sheet preliminary ejection operation has been inserted in the cap open this time is obtained (YES in S1000), the processing proceeds to S1002. In S1002, the conveyance control unit 215D acquires the width of the printing medium in which the waste sheet preliminary ejection operation was inserted last time.

In S1003, it is determined whether the width of the printing medium on which an image is to be printed this time is larger than the width of the printing medium in which the waste sheet preliminary ejection operation was inserted last time. If a result of determination that the width of the printing medium on which an image is to be printed this time is not larger than the width of the printing medium in which the waste sheet preliminary ejection operation was inserted last time is obtained (NO in S1003), the processing proceeds to S1004. If a result of determination that the width of the printing medium on which an image is to be printed this time is larger than the width of the printing medium in which the waste sheet preliminary ejection operation was inserted last time is obtained (YES in S1003), the processing proceeds to S1005. In S1005, the insertion of a waste sheet preliminary ejection operation flag 2 is set to ON. After the processing of S1005 has ended, the flow shown in FIG. 10 is ended.

Specific examples of the determination on insertion of a waste sheet preliminary ejection operation (flag 2) will be described by using FIGS. 11A and 11B. FIG. 11A is a conceptual diagram in which after the cap open, 100 sheets of the printing medium 141 of A4 size are printed, 1 sheet of the printing medium 142 of A3 size is printed, and subsequently, 2 sheets of the printing medium 143 of B3 size are printed. First, as a result of printing 100 sheets from the printing medium 141-1 of A4 size (210 mm×297 mm) to the printing medium 141-100, the printing time accumulation timer is 50 sec, which has exceeded 30 sec of the threshold time Tth. Moreover, at the time when the printing on the printing medium 141-100 has been completed, the sheet width has been expanded from the sheet width 210 mm of the printing medium printed last time to the sheet width 297 mm of the printing medium printed this time. In S1005, the determination on insertion of a waste sheet preliminary ejection operation (flag 1) is set to ON, and the waste sheet preliminary ejection operation of printing a waste sheet preliminary ejection pattern on the printing medium 142-0 is executed before executing the printing this time. Since the waste sheet preliminary ejection operation is executed, after the printing time accumulation timer is reset, 1 sheet of the printing medium 142 of A3 size (297 mm×420 mm) is printed. So far, the description is the same as that of the determination on insertion of a waste sheet preliminary ejection operation (flag 1). Lastly, after the waste sheet preliminary ejection operation for the printing medium 143 of JIS B3 size (364 mm×515 mm) is inserted in the printing medium 143-0, an image is printed on the printing medium 143-1 of JIS B3 size. Note that the insertion of the waste sheet preliminary ejection operation in the printing medium 143-0 is executed by the determination on insertion of a waste sheet preliminary ejection operation (flag 2) described this time.

A specific content up to the determination on insertion of a waste sheet preliminary ejection operation (flag 2) will be described by using the flowchart and the conceptual diagram. In S1001 of FIG. 10, it is determined whether the waste sheet preliminary ejection operation has been inserted in the cap open this time. Since the waste sheet preliminary ejection operation has been inserted in the printing medium 142-0 of FIG. 11A, the determination is YES. In S1002 of FIG. 10, the width of the printing medium in which the waste sheet preliminary ejection operation was inserted last time is acquired. Since the width of the printing medium in which the waste sheet preliminary ejection operation was inserted in the printing medium 142-0 of FIG. 11A is A3 size, 297 mm is acquired. Similarly, in S1003 of FIG. 10, it is determined whether the width of the printing medium on which an image is to be printed this time is larger than the width of the printing medium at the time when the waste sheet preliminary ejection operation was inserted last time. That is, since the printing medium on which an image is to be printed this time in FIG. 11A is the printing medium 143-1 having the size of JIS B3, the width of the printing medium is 364 mm. Since the printing medium at the time when the waste sheet preliminary ejection operation was inserted last time is the printing medium 142-0 having the size of A3, the width of the printing medium is 297 mm. Since the width of the printing medium 143-1 has a larger than the width of the printing medium 142-0 as described above, the determination is YES. As a result, as shown in FIG. 11A, among two waste sheet preliminary ejection operations, the waste sheet preliminary ejection operation on the printing medium 142-0 is executed by the determination on insertion of a waste sheet preliminary ejection operation (flag 1), and the waste sheet preliminary ejection operation on the printing medium 143-0 is executed by the determination on insertion of a waste sheet preliminary ejection operation (flag 2). Note that it can also be said that the nozzles which can be used in the first printing (the printing medium 143-1) include the nozzles which can be used in the second printing (the printing medium 141-1) and the third printing (the printing medium 142-1) conducted before the first printing, and the nozzles which have not been used for a certain period of time or longer. In addition, it can also be said that the nozzles which can be used in the first printing (the printing medium 143-1) include the nozzles which can be used in the second sheet preliminary ejection (the printing medium 142-0) conducted before the first sheet preliminary ejection (the printing medium 143-0) and the nozzle which are not used for a certain period of time or longer. That is, in the case of conducting the first printing on the printing medium 143 whose width in a first direction is a first width after the second printing on the printing medium 141 whose width in the first direction is a second width smaller than the first width, the printing heads 104 are controlled as described below. The printing heads 104 are controlled to conduct a first preliminary ejection on the printing medium 143-0 whose width in the first direction is equal to or larger than the first width after the second printing (the printing medium 141-100) and before the first printing (the printing medium 143-1). In addition, it can also be said that at least one sheet of the printing medium 143-0 for conducting the first preliminary ejection is conveyed before the first sheet of the printing medium 143-1 in the first printing.

The case where only the determination on insertion of a waste sheet preliminary ejection operation (flag 1) was conducted will be described as an example by using a comparative example of FIG. 11B. The width of the printing medium is expanded from 297 mm to 364 mm from the printing medium 142-1 to the printing medium 143-1. However, since insertion of a waste sheet preliminary ejection operation was executed in the printing medium 142-0, at the time of printing on the printing medium 143-1, the printing time accumulation timer has become 0.5 sec, which is a time required for the printing on the printing medium 142-1, and does not exceed 30 sec of the threshold time Tth. Hence the determination on insertion of a waste sheet preliminary ejection operation (flag 1) is set to OFF. As a result, insertion of a waste sheet preliminary ejection operation is not executed immediately before the printing on the printing medium 143-1 of JIS B3 size. That is, the printing on the printing medium 143-1 is executed in the state where the unused nozzle regions in JIS B3 size have an ejection defect. In this comparative example, the reason why such a situation occurs is as follows. That is, in the case where the widths of the printing media to be used for printing from the cap open state to the cap closed state is assumed to be N types (N is an integer of 2 or more), the determination on insertion of a waste sheet preliminary ejection operation (flag 1) is valid until N=2 types. However, in the case where N≥3, there is a case where the printing time accumulation timer is reset at an inappropriate timing depending on the width of the printing medium. In this case, there is a possibility that an ejection defect is generated.

In view of this, in the present embodiment, a condition which is not supported by the determination on insertion of a waste sheet preliminary ejection operation (flag 1) is supported by the determination on insertion of a waste sheet preliminary ejection operation (flag 2), which is a simple determination method in which the widths of the printing media are compared between the waste sheet preliminary ejection operation last time and the printing this time.

As described above, the case where the widths are N types (N=2 types) can be supported by the determination on insertion of a waste sheet preliminary ejection operation flag 1 only, but the determination on insertion of a waste sheet preliminary ejection operation flag 1 is insufficient in the case where N≥3. For this reason, by adding the determination on insertion of a waste sheet preliminary ejection operation (flag 2) to make determination independently from the determination on insertion of a waste sheet preliminary ejection operation (flag 1), a minimum waste sheet preliminary ejection operation can be inserted even in the case where the type N≥3. Note that although the mode of executing the waste sheet preliminary ejection operation with the width of the printing medium to be printed this time has been described, the waste sheet preliminary ejection operation only has to be executed with the width of the printing medium to be printed this time or more, and it is not necessarily required that the waste sheet preliminary ejection operation be executed with the same width as the width of the printing medium to be printed this time.

As described above, according to the present embodiment, it is possible to insert the waste sheet preliminary ejection operation at an appropriate timing even in the case of continuously printing a plurality of types of printing media having different widths. Hence, it is possible to suppress a decrease in image quality of images printed on printing media due to an ejection defect of nozzles. That is, even in the case of printing images on a plurality of types of printing media having different widths, it is possible to appropriately eject inks from nozzles.

### Second Embodiment

In the present embodiment, a mode in which the number of preliminary ejections of a waste sheet preliminary ejection pattern (the number of preliminary ejections) is changed in accordance with a condition will be described. In Embodiment 1, the mode in which 100 droplets are ejected per nozzle on the assumption that the minimum number of droplets required for recovery or more per nozzle of each color are ejected on the sheet surface of a waste sheet in the X direction in FIG. 6 has been described. However, since the waste sheet preliminary ejection is not necessarily inserted periodically, there is a case where the unused time of the unused nozzle regions becomes longer. For this reason, there is a case where waste sheet preliminary ejection of 100 droplets per nozzle uniformly becomes insufficient.

In view of this, in the present embodiment, a mode in which the number of preliminary ejections per nozzle in waste sheet preliminary ejection is changed depending on the time of the printing time accumulation timer will be described. Hereinafter, differences from Embodiment 1 will be mainly described in order to avoid repetitive description.

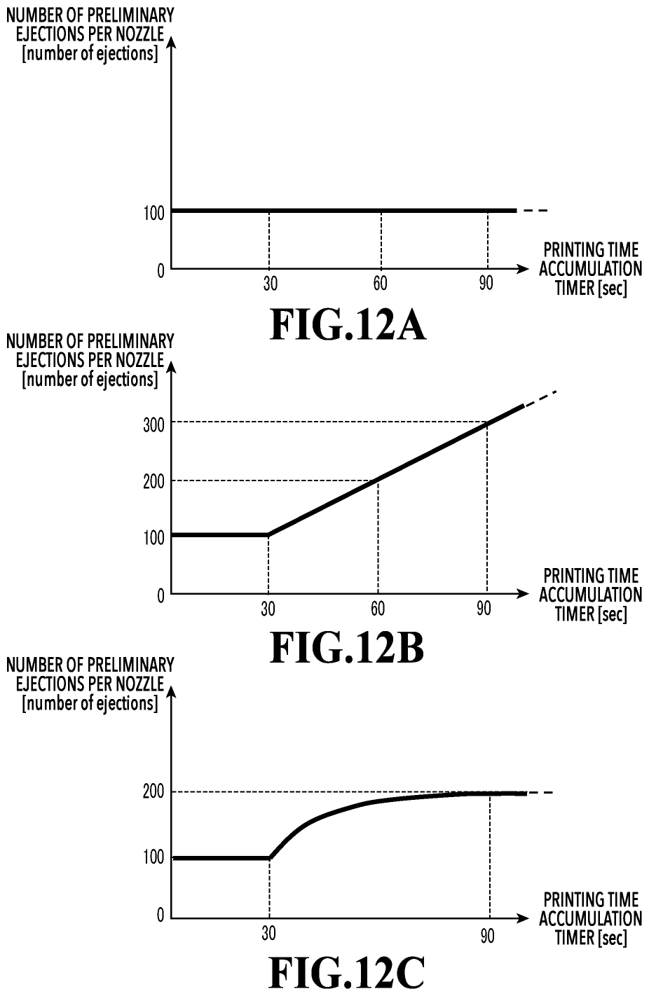

FIGS. 12A to 12C are conceptual diagrams of the number of preliminary ejections per nozzle in waste sheet preliminary ejection in the present embodiment. FIG. 12A shows an example described in FIG. 6 in Embodiment 1. The horizontal axis indicates the printing time accumulation timer [sec], and the vertical axis indicates the number of preliminary ejections per nozzle [number of ejections]. In the determination on insertion of a waste sheet preliminary ejection operation (flag 1), the waste sheet preliminary ejection operation is not inserted with the printing time accumulation timer being equal to or less than 30 sec of the threshold time Tth, while in the determination on insertion of a waste sheet preliminary ejection operation (flag 2), the waste sheet preliminary ejection operation is inserted irrespective of the value of the printing time accumulation timer. In view of this, the number of preliminary ejections per nozzle is set to 100 irrespective of the value of the printing time accumulation timer.

FIGS. 12B and 12C show relations between the printing time accumulation timer and the number of preliminary ejections in the present embodiment. The case where the printing time accumulation timer is equal to or less than 30 sec of the threshold time Tth is the same as in Embodiment 1; however, once the printing time accumulation timer exceeds 30 sec of the threshold time Tth, the number of preliminary ejections per nozzle is increased in proportion to the printing time accumulation timer. This is because the ejection performance decreases as the unused time of the unused nozzles becomes longer. FIG. 12B shows the case where the number of ejections per nozzle is increased such that the relation between the length of the accumulated time and the number of preliminary ejections per nozzle becomes linear in accordance with the length of the accumulated time. FIG. 12C shows the case where the number of ejections per nozzle is increased such that the relation between the length of the accumulated time and the number of preliminary ejections per nozzle becomes non-linear in accordance with the length of the accumulated time. This is because there is also a case where if the increase in viscosity of the ink of unused nozzles proceeds to a certain extent, the increase in viscosity of the ink becomes in an equilibrium state, so that the number of preliminary ejections necessary for recovery does not increase. Since the relation between the printing time accumulation timer and a necessary number of preliminary ejections varies depending on the type of the ink, the head temperature adjustment condition, the environmental temperature and humidity conditions around the printing apparatus, and the like, the configuration may be changed as necessary.

As described above, according to the present embodiment, the number of preliminary ejections per nozzle can be increased in accordance with the length of the unused time of nozzles included in unused nozzle regions. This makes it possible to more appropriately prevent generation of an ejection defect of nozzles included in unused nozzle regions.

### Third Embodiment

In the present embodiment, a mode in which the number of preliminary ejections for a waste sheet preliminary ejection pattern is changed relative to a Y direction, which is a nozzle array direction, in accordance with a condition will be described. In Embodiment 1, the mode in which 100 droplets are ejected per nozzle on the assumption that the minimum number of droplets required for recovery or more per nozzle of each color are ejected on the sheet surface of a waste sheet in the X direction in FIG. 6 has been described. However, if unused nozzle regions and a used nozzle region are compared, necessary numbers of preliminary ejections are actually different, and a necessary number of preliminary ejections is relatively larger in the unused nozzle regions than in the used nozzle region.

In view of this, in the present embodiment, a mode in which the number of preliminary ejections for unused nozzle regions is changed in accordance with a condition will be described. Hereinafter, differences from Embodiment 1 and Embodiment 2 will be mainly described in order to avoid repetitive description.

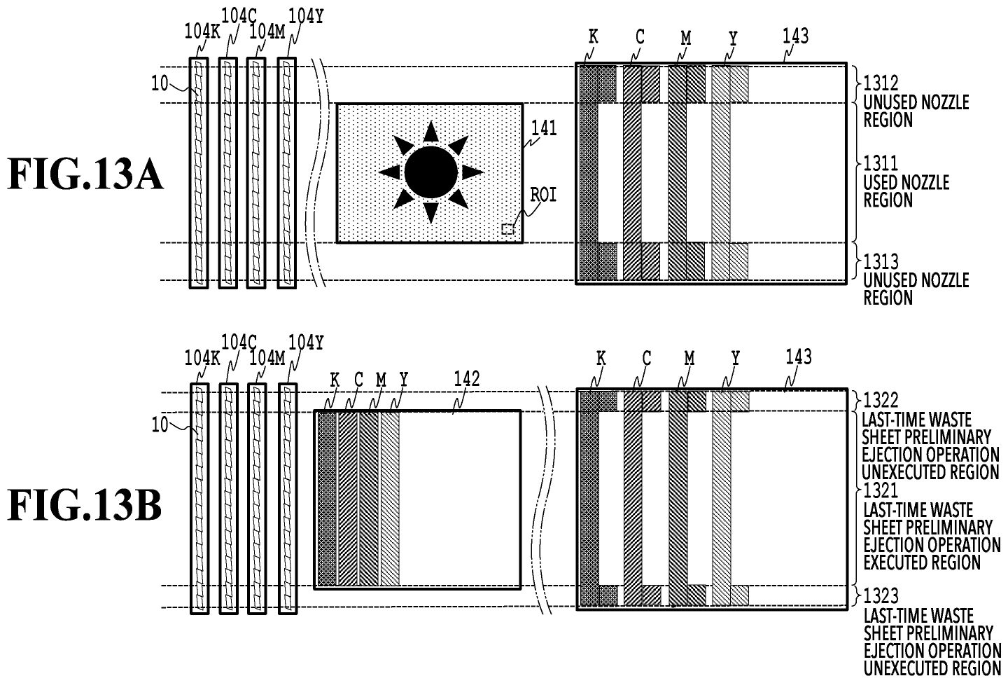

FIGS. 13A and 13B are conceptual diagrams of waste sheet preliminary ejection patterns in the present embodiment. FIG. 13A shows the case of the determination on insertion of a waste sheet preliminary ejection operation (flag 1), while FIG. 13B shows the case of the determination on insertion of a waste sheet preliminary ejection operation (flag 2).

First, a change of a preliminary ejection pattern to be inserted in the determination on insertion of a waste sheet preliminary ejection operation (flag 1) will be described by using FIG. 13A. FIG. 13A is a conceptual diagram in which printing of an image and a sheet preliminary ejection have been executed on a printing medium 141, and thereafter, a waste sheet preliminary ejection operation is executed on a printing medium 143. Compared with a used nozzle region 1311, the number of waste sheet preliminary ejections is increased by twice in unused nozzle regions 1312, 1313. Note that the increase is not limited to twice, but may be twice or more. This is because it is preferable to increase the number of preliminary ejections for the unused nozzle regions 1312, 1313 which are under relatively disadvantageous conditions in terms of the ejection state where the preliminary ejection operation cannot be conducted as compared with the used nozzle region 1311 where the ejection state can be maintained to some extent by the printing of an image, a sheet preliminary ejection, and the like. That is, it can be said that among the nozzle regions 1311 to 1313 in which the first sheet preliminary ejection can be executed, the number of preliminary ejections per nozzle is increased in the nozzle regions 1312, 1313 which are not used in a second printing, as compared with the nozzle region 1311 which is used in the second printing.

Next, a change of a preliminary ejection pattern to be inserted in the determination on insertion of a waste sheet preliminary ejection operation (flag 2) will be described by using FIG. 13B. As described in FIG. 10, in the determination on insertion of a waste sheet preliminary ejection operation (flag 2), it is determined whether the insertion is conducted by comparing the width of a printing medium on which an image is to be printed this time and the width of a printing medium in which the waste sheet preliminary ejection operation was inserted last time. Here, it is assumed that the width of the printing medium on which an image is to be printed this time is that of the printing medium 143, that is, JIS B3 size (364 mm×515 mm), while the width of the printing medium in which the waste sheet preliminary ejection operation was inserted last time is that of the printing medium 142, that is, A3 size (297 mm×420 mm). In FIG. 13B, last-time waste sheet preliminary ejection operation unexecuted regions 1322, 1323 correspond to a difference in width between the printing medium 143 and the printing medium 142, and these regions are in the state where the preliminary ejection operation has not been executed for a long period of time. In view of this, the number of waste sheet preliminary ejections is increased by twice in the last-time waste sheet preliminary ejection operation unexecuted regions 1322, 1323 as compared with a last-time waste sheet preliminary ejection operation executed region 1321. Note that the increase is not limited to twice, but may be twice or more. It can also be said that among the nozzle regions 1321 to 1323 in which the first sheet preliminary ejection is executed, the number of preliminary ejections per nozzle is increased in the nozzle regions 1322, 1323 in which the second sheet preliminary ejection is not executed as compared with the nozzle region 1321 in which the second sheet preliminary ejection was executed.

Note that there is a case where both of the determination on insertion of a waste sheet preliminary ejection operation (flag 1) and the determination on insertion of a waste sheet preliminary ejection operation (flag 2) are simultaneously changed to ON. In this case, a waste sheet preliminary ejection operation for one having a larger length in the Y direction among the unused nozzle regions and the waste sheet preliminary ejection operation unexecuted regions may be inserted.

As described above, the present embodiments make it possible to achieve recovery with small amounts of waste inks by relatively increasing the number of waste sheet preliminary ejections of the unused nozzle regions or the waste sheet preliminary ejection operation unexecuted regions.

### OTHER EMBODIMENTS

The present disclosure is not limited to the above-described embodiments, and various modifications may be made, and parts of the above-described embodiments may be combined as appropriate.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present embodiments make it possible to suppress an ejection defect of nozzles even in the case of continuously printing images on a plurality of types of printing media having different widths.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. A printing apparatus comprising:
a printing unit which prints images on a plurality of types of printing media having different widths in a first direction by ejecting an ink from a plurality of nozzles arrayed in the first direction; and
a control unit which controls the printing unit to conduct a preliminary ejection of ejecting the ink which does not contribute to the printing of an image from the plurality of nozzles onto the printing media in order to maintain an appropriate ejection state of the plurality of nozzles,
wherein, in a case of conducting first printing on a first printing medium whose width in the first direction is a first width after second printing on a second printing medium whose width in the first direction is a second width smaller than the first width, the control unit controls the printing unit to conduct a first preliminary ejection on a printing medium whose width in the first direction is equal to or larger than the first width after the second printing and before the first printing.

2. The printing apparatus according to claim 1, further comprising a conveyance unit which conveys a printing medium in a second direction intersecting the first direction.

3. The printing apparatus according to claim 2, wherein the printing medium to be conveyed by the conveyance unit is a cut printing medium, and
at least one sheet of the printing medium for conducting the first preliminary ejection is conveyed before a first sheet of the printing medium in the first printing.

4. The printing apparatus according to claim 1, further comprising an acquisition unit which acquires an accumulated time since start of the printing,
wherein, in a case when the first printing is conducted after the second printing and where the accumulated time has exceeded a threshold time, the control unit conducts the first preliminary ejection on a printing medium whose width in the first direction is equal to or larger than the first width.

5. The printing apparatus according to claim 1, wherein, in a case when the first width is larger than a third width in the first direction of a third printing medium on which a second preliminary ejection was conducted before the first preliminary ejection, the control unit conducts the first preliminary ejection on a printing medium whose width in the first direction is equal to or larger than the first width.

6. The printing apparatus according to claim 1, further comprising:
an acquisition unit which acquires an accumulated time since the start of printing the image,
wherein, in a case when the first width is larger than the second width and the accumulated time has exceeded a threshold time, or,
in a case when the first width is larger than a third width in the first direction of a third printing medium on which a second preliminary ejection was conducted before the first preliminary ejection,
the control unit conducts the first preliminary ejection on a printing medium whose width is equal to or larger than the first width.

7. The printing apparatus according to claim 6, wherein the control unit increases the number of preliminary ejections per the nozzle in accordance with a length of the accumulated time.

8. The printing apparatus according to claim 4, wherein the control unit increases the number of preliminary ejections per the nozzle such that a relation between a length of the accumulated time and the number of preliminary ejections per the nozzle becomes linear in accordance with the length of the accumulated time.

9. The printing apparatus according to claim 4, wherein the control unit increases the number of preliminary ejections per the nozzle such that a relation between a length of the accumulated time and the number of preliminary ejections per the nozzle becomes non-linear in accordance with the length of the accumulated time.

10. The printing apparatus according to claim 1, wherein, among the nozzles on which the first preliminary ejection can be executed, the control unit increases the number of preliminary ejections per the nozzle in the nozzles which are not used in a second printing conducted before the first printing, as compared with the nozzles which are used in the second printing.

11. The printing apparatus according to claim 10, wherein the number of preliminary ejections per the nozzle in the nozzles which are not used in the second printing is twice or more the number of preliminary ejections per the nozzle in the nozzles which are used in the second printing.

12. The printing apparatus according to claim 1, wherein, among the nozzles on which the first preliminary ejection is executed, the control unit increases the number of preliminary ejections per the nozzle in the nozzles on which a second preliminary ejection which is executed before the first preliminary ejection is not executed, as compared with the nozzles on which the second preliminary ejection was executed.

13. The printing apparatus according to claim 12, wherein the number of preliminary ejections per the nozzle in the nozzles on which the second preliminary ejection is not executed is twice or more the number of preliminary ejections per the nozzle in the nozzles on which the second preliminary ejection is executed.

14. The printing apparatus according to claim 1, wherein the control unit controls the printing to execute a preliminary ejection at a timing when a width of a printing medium on which the printing was conducted changes.

15. The printing apparatus according to claim 1, wherein a printing head including the nozzles is capable of ejecting a cyan ink, a magenta ink, a yellow ink, and a black ink, and
the control unit controls the printing to print a preliminary ejection pattern of each of the cyan ink, the magenta ink, the yellow ink, and the black ink on a printing medium which is not used in the printing.

16. The printing apparatus according to claim 15, wherein the preliminary ejection pattern is composed of color bars respectively of cyan, magenta, yellow, and black, and is formed by ejecting a minimum number of droplets required for recovery or more per nozzle corresponding to each of the cyan, the magenta, the yellow, and the black onto a printing medium which is not used in the printing, in a direction intersecting a width direction of the printing medium.

17. The printing apparatus according to claim 1, wherein a printing head which is provided with the nozzles is a line-type printing head in which the nozzles are arrayed along a width of the printing medium.

18. The printing apparatus according to claim 1, further comprising a storage unit which stores printing information indicating widths of the printing media on which printing of a user image and a preliminary ejection are conducted, respectively.

19. A method of controlling a printing apparatus that includes a printing unit which prints images on a plurality of types of printing media having different widths in a first direction by ejecting an ink from a plurality of nozzles arrayed in the first direction, and a control unit which controls the printing unit to conduct a preliminary ejection of ejecting the ink which does not contribute to the printing of an image from the plurality of nozzles onto the printing media in order to maintain an appropriate ejection state of the plurality of nozzles, the method comprising:
in a case of conducting first printing on a first printing medium whose width in the first direction is a first width after second printing on a second printing medium whose width in the first direction is a second width smaller than the first width, causing the control unit to control the printing unit to conduct a first preliminary ejection on a printing medium whose width in the first direction is equal to or larger than the first width after the second printing and before the first printing.

20. A non-transitory computer readable storage medium storing a program causing a computer to execute a method of controlling a printing apparatus that includes a printing unit which prints images on a plurality of types of printing media having different widths in a first direction by ejecting an ink from a plurality of nozzles arrayed in the first direction, and a control unit which controls the printing unit to conduct a preliminary ejection of ejecting the ink which does not contribute to the printing of an image from the plurality of nozzles onto the printing media in order to maintain an appropriate ejection state of the plurality of nozzles, the method comprising:
in a case of conducting first printing on a first printing medium whose width in the first direction is a first width after second printing on a second printing medium whose width in the first direction is a second width smaller than the first width, causing the control unit to control the printing unit to conduct a first preliminary ejection on a printing medium whose width in the first direction is equal to or larger than the first width after the second printing and before the first printing.
